(19) United States
(12) Patent Application Publication
(10) Pub. No.: US 2010/0245772 A1
(43) Pub. Date: Sep. 30, 2010

(54) OPTICAL FILTER, PROJECTION DISPLAY, AND METHOD FOR MANUFACTURING OPTICAL FILTER

(75) Inventor: Yoshiji KAWAMURA, Tochigi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: FUJINON SANO CORPORATION, Sano-shi (JP)

(21) Appl. No.: 12/814,016

(22) Filed: Jun. 11, 2010

Related U.S. Application Data
(63) Continuation of application No. 11/868,073, filed on Oct. 5, 2007.

(30) Foreign Application Priority Data
Oct. 11, 2006 (JP) 2006-277425
Apr. 18, 2007 (JP) 2007-109178

(51) Int. Cl. G02B 5/30; G02B 5/22; G03B 21/14

(52) U.S. Cl. 353/20; 359/890; 359/497

(57) ABSTRACT

An optical filter capable of removing an unnecessary component of incident light. The optical filter has a transparent body of a flat plate-like shape. A plurality of filtering layers, each that separate an unnecessary polarization component of incident light from a necessary polarization component, are formed within the transparent body in series and at uniform intervals with an angle inclination relative to the travel direction of incident light. A plurality of light-absorptive layers are formed within the transparent body in series and at uniform intervals between the filtering layers to absorb an unnecessary component reflected by the filtering layers.

### CROSS-REFERENCE TO RELATED APPLICATION

The present application is a Continuation of U.S. Ser. No. 11/868,073, filed Oct. 5, 2007, which is hereby incorporated herein by reference in its entirety and claims the benefit from Japanese Patent Application Nos. 2006-277425, filed Oct. 11, 2006, and 2007-109178, filed Apr. 18, 2007.

### BACKGROUND OF THE INVENTION

1. Field of the Art

This invention relates to an optical filter adapted to transmit a specific light component alone, a projection display applying such an optical filter, and a method for manufacturing the same.

2. Prior Art

In a liquid crystal projector, typical of projection displays, while light from a light source is decomposed into three color components of blue, green and red by color separation using optical elements like dichroic mirrors which are capable of transmitting and reflecting specific wave ranges. The respective color components are modulated separately by the use of liquid crystal display devices, and synthesized into a color image by means of a color synthesizing dichroic device for projection on a screen.

By the use of polarized beam splitters which are adapted to transmit or reflect incident light depending upon the direction of polarization, the decomposed color components are led to a color synthesizing dichroic element to synthesize light-modulated signal light. At the time of light modulation by a liquid crystal display device, the direction of polarization is turned 90 degrees as signal light is reflected off. That is to say, light components of p- and s-polarizations, which are incident from the side of a light source, are reversed to s- and p-polarizations, respectively, as they are modulated into signal light. Accordingly, signal light resulting from light modulation of each color can be transmitted or reflected in a direction different from the direction of incidence, for leading the signal light to a dichroic element.

In this regard, as a matter of fact it is extremely difficult to separate incident light into p-polarized light and s-polarized light completely because each polarized light beam splitter has an extinction factor (i.e., a ratio of p-polarized light to s-polarized light in transmitted or reflected light. This means that input light to be modulated into signal light inevitably contains an unnecessary polarization component which would make accurate light modulation difficult and invite degradations in quality of picture images. In this connection, Japanese Laid-Open Patent Application H9-80356 discloses as a third embodiment an arrangement for eliminating unnecessary polarizations before entrance to a polarized beam splitter. More particularly, in a third embodiment of Japanese Laid-Open Patent Application H9-80356, another polarized beam splitter with the same optical properties as a proper polarized beam splitter is located in a stage anterior to the proper polarized beam splitter to serve as a filter for removing unnecessary polarizations. In this case, an extinction factor of the proper polarized beam splitter is increased by transmitting input light through a filtering polarized beam splitter which is located in a position anterior to the main polarized beam splitter.

It is a light separation layer which is formed internally of a polarized beam splitter that performs the function of transmitting and reflecting polarized light components depending upon the direction of polarization. The light separation layer is adapted to separate p- and s-polarized light by transmitting one polarization while reflecting off the other polarization, utilizing differences in behaviors, and severely controlled in various conditions including the layer thickness and the number of laminated layers, and angle relative to incident light.

However, in the case of the polarized beam splitter Laid-Open Patent Application H9-80356 mentioned above, minute optical elements are mounted on a support member in the shape of a staircase for the purpose of shortening a light path of a prism. Arrangements are made such that light separation layers of the minute optical elements on the support member are located in the same plane. That is to say, the coplanarity of small optical elements is maintained by the support member. Namely, depending upon the mounting accuracy, light separation layers on the respective optical elements can be mounted unsatisfactorily in levelness to such a degree as to make it extremely difficult to maintain coplanarity. Especially in the case of a projection display using component parts which are reduced in size in order to meet a demand for compactness in construction, as a matter of fact it is impossible to position minute optical elements in the same plane on a support member.

As mentioned above, a polarized beam splitter is required to satisfy severe conditions in order to split polarized components of incident light. If polarization splitting layers were defective in coplanarity, it would become difficult for a polarized beam splitter to play a role as a filter to a satisfactory degree. In that case, unnecessary light is transmitted and fed to a proper polarized beam splitter to give adverse effects by appearing as ghost in an picture image projected on a screen. Especially, because of the conspicuous recent advancements in picture quality of liquid crystal projectors, there is a strong demand for an optical filter with a satisfactory filtering function to eliminate unnecessary light as much as possible.

### SUMMARY OF THE INVENTION

It is an object of the present invention to provide an optical filter which is compact in form but can ensure a high filtering performance, and a projection type display applying such an optical filter.

According to the present invention, there is provided an optical filter capable of removing an unnecessary component of incident light, comprising: a plural number of filtering layers each having functions of transmitting a necessary component of incident light while reflecting off an unnecessary component, said filtering layers being provided in series and at uniform intervals internally of a transparent flat plate-like body with a predetermined inclination angle relative to travel direction of incident light; and a plural number of light-absorptive means each having functions of absorbing said unnecessary component of incident light reflected at said filtering layers, said light-absorptive means been provided internally of said transparent plate-like body in series and at uniform intervals correspondingly to said filtering layers.

The optical filter is in a flat plate-like shape and reduced in thickness, so that it can contribute to downsize optical appliances into a compact form. Besides, an unnecessary light component separated by the filtering layers is reflected toward the light-absorptive members, which are adapted to absorb the energy of the unnecessary light component to blot up same within the filter. That is to say, there is no possibility of an filtered-out unnecessary component leaking from the filter to give adverse effects on picture images.

In the above-described optical filter, light-absorptive deposition film layers (light-absorptive dielectric multi-layer deposition film layers) can be applied to the light-absorptive layers. Light-absorptive deposition film layers of this sort can be formed, for example, by alternately laminating a Cr layer and an SiO₂ layer for a plural number of times. Although the light-absorptive layers function to absorb an unnecessary light component, they may fail to blot up unnecessary light completely, leaving possibilities of part of unnecessary light leaking from the filter. In such a case, unnecessary light which has leaked through an absorptive layer is reflected by an adjacent filtering layer in the same direction as the necessary component. In order to preclude this problem, a shield layer is deposited on each absorptive layer thereby blocking unnecessary component, which has permeated through the absorptive layer, from traveling toward an adjacent filtering layer.

As a shield layer, a reflective layer can be applied. By the use of a reflective shield layer, light which has permeated through an absorptive layer can be reflected back and its further travel in the direction of an adjacent filtering layer can be completely blocked. A reflective layer of this sort can be formed by deposition of a metal layer such as an Al, Cr, or Ti layer. A metal layer of this sort can totally reflect or absorb incident light (reflecting off a major part and absorbing a minor part of incident light), precluding of possibilities of light passage therethrough. Thus, a reflective shield layer can completely shut out passage of light in an assured manner. In a case where a reflective layer is employed as a shield layer, part of unnecessary light which has permeated through an absorptive layer is reflected back and cast on the absorptive layer again. That is to say, partly remaining unnecessary light is cast again on the absorptive layer and its energy is completely blotted up.

On the other hand, a light-absorptive adhesive layer can be formed on the above-mentioned light-absorptive layer. In the course of fabrication of the optical filter, a plural number of transparent body plates are stacked and bonded together and cut into filter block units before or after deposition of filtering and light-absorptive layers. Therefore, an adhesive is necessarily applied to each absorptive layer. Therefore, by using an adhesive agent with light absorbing properties, it becomes possible to let the light-absorptive adhesive agent absorb part of unnecessary light which has permeated through a light-absorptive layer and which would otherwise leak toward an adjacent filtering layer. As a light-absorptive adhesive agent, it is possible to apply an adhesive agent containing a light-absorptive pigment. In such a case, a role as a shield layer can be played by an adhesive agent which is necessarily used in the fabrication of the optical filter, making it unnecessary to provide an adhesive layer separately from a light-absorptive layer.

As for a light-absorptive member, instead of a light-absorptive deposition layer, it is possible to use a light-absorptive adhesive agent alone which can also play the role of a light-absorptive layer. Namely, a light-absorptive adhesive agent with light absorbing properties can give a performance as a light-absorptive member alone. However, the adhesive agent to be used should be capable of completely absorbing unnecessary light reflected off the filtering layers. Further, in a case where a light-absorptive adhesive agent alone is employed for absorption of reflected unnecessary light, there may arise a situation in which the adhesive agent is put in high temperature conditions as a result of absorption of light energy. In such a case, it is desirable to apply a heat-resistant light-absorptive adhesive agent like a silicone adhesive agent, for example. A silicone adhesive agent, which contains various heat conducting filler materials, has satisfactory properties in heat radiation and can be suitably applied as a heat-resistant light-absorptive adhesive agent.

The optical filter can be used for a diversity of filtering functions. For example, the optical filter can be applied as a polarization filter with a function of transmitting either one of p- and s-polarizations while blotting up the other polarization by absorptive layers. In this case, the filtering layers of the filter function as polarization separating layers. Alternatively, the optical filter can be applied as an infrared filter for filtering out an infrared component of incident light. In this case, the optical filter functions to filter out and absorb an infrared component of incident light while transmitting other components through. Otherwise, the optical filter can be applied to transmit an infrared component of incident light while reflecting off other components. Namely, the optical filter can perform a filtering function on the basis of direction of polarization or wavelength range.

The optical filter of the present invention has a wide range of applications. For example, it can be applied to a liquid crystal projector as a polarization filter for filtering out a particular component from a light beam to be fed to a polarized beam splitter. In this case, pure and clear polarized light, free of unnecessary noisy components, can be fed to a polarized beam splitter for the purpose of improving picture quality. Besides, the optical filter can be applied to optical pickups and the like.

According to the present invention, there is also provided a method for manufacturing an polarization filter, comprising the steps of: coating a surface on one side of a plural number of flat transparent body plates with a filtering layer to transmit necessary component of incident light and to reflect off an unnecessary component of incident light; stacking resulting filter plate units to build up a stack of a staggered staircase-like shape; slicing a resulting staircase stack at a predetermined pitch with obliquely at the same angle as an angle of inclination of the staircase stack; forming a light-absorptive means on a surface on one side or on both sides of sliced staircase blocks; stacking said staircase blocks straight up to form a filter matrix block; and cutting the filter matrix block along uniformly spaced vertical cut lines to obtain filter unit blocks.

In order to have filtering effects on all of incident light rays, the above-described optical filter needs to have a plural number of filtering layers formed in series and continuously in a gapless form in a direction perpendicular to the incident light rays. According to the filter manufacturing method of the invention, filter unit blocks are cut from a straight filter matrix block which is formed by building up a plural number of coated staircase blocks one on another in a gapless state in a direction perpendicular to incident light rays. That is to say, the filter unit blocks which are eventually obtained by the method of the invention have a series of filtering layers gapless in a direction perpendicular to incident light rays.

In the optical filter manufacturing method according to the present invention, a plural number of filter plate units, each coated with a filtering layer, are bonded together preferably by the use of an optical adhesive agent which matches with the transparent body material of the filter in refractivity and is satisfactory in transmittance, while using a heat resistant adhesive agent in the step of bonding together coated staircase blocks. Light energy absorbed by a light-absorptive layer is converted into thermal energy to put the absorptive layer in high temperature conditions. However, defoliation of an absorptive layer in high temperature conditions can be prevented by the use of a heat resistance adhesive agent.

As described above, the optical filter of the present invention is in the shape of a flat plate, achieving the objective of downsizing the filter into a compact form. In addition, by blotting up an unnecessary light component by the use of light-absorptive layers, the filter realizes a high filtering function which will lead to improvements in picture quality. Furthermore, the polarization filter manufacture method of the present invention permits to fabricate a polarization filter with high precision.

The above and other objects, features and advantages of the present invention will become apparent from the following particular description of the invention, taken in conjunction with the accompanying drawings which show by way of example preferred embodiments of the invention. Needless to say, the present invention should not be construed as being limited to the particular forms shown in the drawings.

### BRIEF DESCRIPTION OF THE DRAWINGS

In the accompanying drawings:

FIG. 1 is a schematic illustration showing part of a reflection type liquid crystal projector;

FIG. 2 is a schematic sectional view of a polarization filter;

FIG. 3 is an enlarged schematic view of a polarization filter having an absorptive layer deposited at one side of a filtering layer;

FIG. 4 is an enlarged schematic view of a polarization filter having an absorptive layer deposited on both sides of a filtering layer;

FIG. 5 is a flow chart showing steps of a process for fabricating a polarization filter;

FIG. 6 is a schematic illustration explanatory of steps S1 to S4 of the polarization filter fabrication process;

FIG. 7 is a schematic illustration explanatory of steps S6 to S8 of the fabrication process; and

FIG. 8 is a schematic illustration showing a polarization filter which is adapted to reflect p-polarized light and transmit s-polarized light.

### DESCRIPTION OF PREFERRED EMBODIMENTS

Hereafter, with reference to the accompanying drawings, the present invention is described more particularly by way of its preferred embodiments in which the optical filter is applied as a polarization filter. A polarization filter has a function of transmitting either p- or s-polarized light whichever is actually used as signal light, while filtering out or eliminating the other polarization as unnecessary light. An optical filter according to the present invention can be applied as an arbitrary optical filter intended for other purposes, for example, as an infrared filter having a function of filtering out infrared components as unnecessary light.

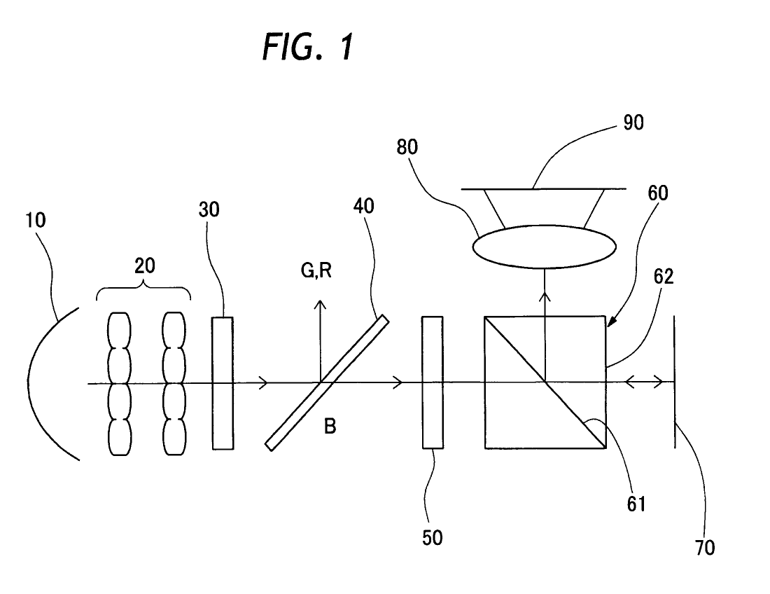

Shown schematically in FIG. 1 is part of a reflection type liquid crystal projector as an example of a projection display. The reflection type liquid crystal projector shown in FIG. 1 is composed of a light source 10, fly-eye lenses 20, a polarization converting element 30, a dichroic mirror 40, a polarization filter 50, a polarized beam splitter 60, a liquid crystal display device 70 and a screen 90.

For emission of while light, for example, the light source 10 is provided with an illuminant and a reflector. White light emitted from the illuminant is reflected by the reflector to project white light at a high condensation rate. A flux of white light from the light source 10 is fed to the fly-eye lenses 20, each having a number of unitary lens elements arrayed in rows and columns in eccentric positions relative to the other, thereby dispersing unevenness in luminance of the light flux from the light source 10, that is, uniformly distributing luminance across the light flux. Past the fly-eye lenses 20, the flux of white light is fed to the polarization converting element 30 which has a function of converting white light into linearly polarized light.

After conversion to linearly polarized light by the polarization converting element 30, the light flux of white light is fed to the dichroic mirror 40, an optical color separating device which separates colors by transmitting or reflecting incident light depending upon wave ranges. In this instance, the dichroic mirror 40 has optical characteristics to transmit light of a blue range alone, reflecting off other wave ranges. Thus, as shown in FIG. 1, light of a blue range (indicated by letter “B”) alone is transmitted through the dichroic mirror 40 while light of a green range (indicated by letter “G”) as well as light of a red range (indicated by letter “R”) is reflected off.

Blue range light which has been transmitted through the dichroic mirror 40 is fed to the polarization filter 50 with a filtering function of transmitting only a blue component necessary for making a picture image (signal light) while filtering out other components (unnecessary light). More particularly, in this instance, the polarization filter 50 transmits only p-polarized blue light as signal light, while filtering out other polarization (s-polarized light) as an unnecessary light. Accordingly, pure blue light of p-polarization alone is fed to the polarized beam splitter 60.

The polarized beam splitter 60 is an optical element which either transmits or reflects incident light depending upon the direction of polarization. In this particular embodiment, the polarized beam splitter 60 is described as having optical properties to transmit p-polarized light while reflecting off s-polarized light. However, it is also possible to use a polarized beam splitter in other applications in which it is required to reflect off p-polarization while transmitting s-polarization. In order to impart the polarization separating action, a polarization separator coating 61 in the form of a dielectric multi-layer deposition film is formed on the polarized beam splitter 60. Normally, the polarized beam splitter 60 has the polarization separator coating 61 formed internally of a cubic prism 62 of glass material or the like.

As mentioned above, blue light incident on the polarized beam splitter 60 is p-polarized light. Therefore, blue light incident on the polarization separator coating 61 is transmitted through toward the liquid crystal display device 70, which is a reflective light valve adapted to modulate the direction of polarization of incident light (light modulation) in relation with selection (ON) and non-selection (OFF) of each picture element. For this purpose, correspondingly to the respective picture elements, switching elements are arrayed on the liquid crystal display device 70, thereby applying a voltage to liquid crystal molecules of the respective picture elements. When a voltage is applied to liquid crystal molecules, a change occurs to the direction of a liquid crystal molecule array, shifting liquid crystal molecules in such a direction as to rotate the direction of polarization of incident light through 90 degrees. Accordingly, when a picture element is in a selected state, incident p-polarized light is modulated in direction of polarization and reflected toward the polarized beam splitter 60 as s-polarized light. On the other hand, when a picture element is in an unselected state, no voltage is applied to liquid crystal molecules and no change occurs to the direction of a liquid crystal molecule array. Thus, in this case, no modulation takes place in direction of polarization, and p-polarized light is reflected toward the polarized beam splitter 60 as it is (as p-polarized light).

Blue light reflected off the liquid crystal display device 70 is cast again on the polarization separator coating 61 of the polarized beam splitter 60. Blue light of an unselected picture element, which is p-polarized light, is transmitted through the polarization separator coating 61. On the other hand, blue light of a selected picture element, which is s-polarized light, is reflected off the polarization separator coating 61. Blue light of selected picture elements, reflected off the polarization separator coating 61, is led to a projection lens 80 thereby to project a picture image on a screen 90.

Only blue component is dealt with in the foregoing description, but the green and red components are separated in a similar manner by the use of dichroic mirrors which are not shown in the drawing, followed by light-modulation by the use of an exclusive liquid crystal display device for each color. After light modulation, blue, green and red components are synthesized into a color image by means of a color synthesizing dichroic mirror which is not shown, and projected on the screen 90 by the projection lens 80.

When blue light is converted into p-polarized light by the polarization converting element 30, the output light is not totally p-polarized light and does contain a slight amount of s-polarized light. After transmission through the polarization converting element 30, blue light is separated from other color components by the dichroic mirror 40 before entering the polarized beam splitter 60. Therefore, the proportion of unnecessary light can be increased by the dichroic mirror 40 to invite degradations in quality of projected picture images, for example, by appearing as a ghost in a picture image projected on the screen 90. Therefore, it is important to remove unnecessary light components by the polarization filter 50 with a filtering function, which is located immediately anterior to the polarized beam splitter 60.

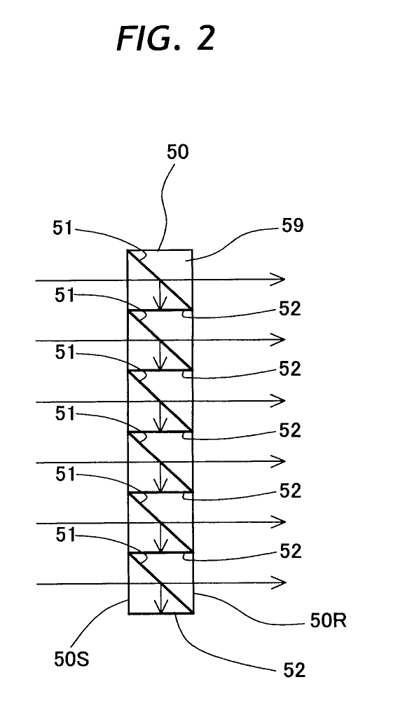

The polarization filter 50 is in the shape of a flat plate as seen particularly in FIG. 2 which shows the polarization filter 50 in a sectional view. On the front side, the polarization filter 50 is formed with a plane of incidence 50S, and, on the rear side, with a plane of egression 50R. The plane of incidence 50S as well as the plane of egression 50R is disposed perpendicularly to incident light rays, and has a breadth sufficient for covering a spot diameter of incident light to give filtering effects on all of incident light rays. The polarization filter 50 is provided with a plural number of polarization filtering layers 51, which are formed in series and at uniform intervals internally of a transparent body material like glass with a predetermined inclination angle relative to incident light rays (e.g., at an angle of 45 degrees). Each one of the polarization filtering layers is in the form of a dielectric multi-layer deposition film with optical properties to transmit either one of p- and s-polarizations while reflecting off the other polarization. In function, the polarization filtering layer is same as the polarized light separator layer 61 which is formed on the polarized beam splitter 60 as a dielectric multi-layer deposition film and imparted with an optical function to transmit p-polarized light while reflecting off s-polarized light.

In order to let the polarization filter 50 perform a filtering action effectively, it is a must for all of incident light rays to fall on the polarization filtering layers 51. On the part of the polarization filtering layers 51 which are formed in series on the polarization filter 50, they have to be continuously connected with adjacent polarization layers 51 in a direction perpendicular to the direction of propagation of incident light rays to produce the polarization filtering effects on all of incident light rays. In case a gap is opened up between adjacent polarization filtering layers 51, leaks of unnecessary light take place through the interstice to give adverse effects on picture images to be formed. Therefore, the polarization filtering layers 51 should be continuously connected in the direction mentioned above.

By the polarization filtering function of the polarization filter 50, an unnecessary component of s-polarization is filtered out while signal light of p-polarization is transmitted through the filter 50. At this time, it is necessary to prevent the removed unnecessary component from being cast again in the direction of the polarized beam splitter 60. In this regard, removed unnecessary light may be diverted in other directions from inside the polarization filter 50. However, since a large number of polarization filtering layers 51 exist internally of the polarization filter 50, there may arise a situation in which an unnecessary component reflected off the polarization filtering layers 51 is turned toward the polarized beam splitter 60 by reflection on adjacent polarization filtering layers 51. Besides, the polarization filter 50 is made in a transparent body material like glass so that there is a difference in refractivity between the transparent body material and surrounding air. That is to say, when unnecessary light is put away out of the polarization filter 50, there is a possibility of unnecessary light being reflected off toward the polarized beam splitter 60 at a boundary surface of the polarization filter 50 due to a difference in refractivity.

Therefore, according to the present invention, the polarization filter 50 is provided with absorption layers 52 thereby to blot up unnecessary light instead of expelling same out of the filter 50. As shown in FIG. 2, the polarization filter 50 is provided with absorption layers 52 correspondingly to the respective polarization filtering layers 52. Each absorption layer 52 is a dielectric multi-layer deposition film with light-absorptive properties, and so formed and disposed to absorb unnecessary light filtered out by an adjoining filtering layer 51. Thus, unnecessary light which is filtered out by the respective filtering layers 51 is absorbed by the adjoining absorption layers 52, precluding possibilities of filtered-out unnecessary light being directed toward the polarized beam splitter 60. The absorption layer 52 can be realized, for example, by alternately laminating a Cr layer and a SiO₂ layer for a plural number of times.

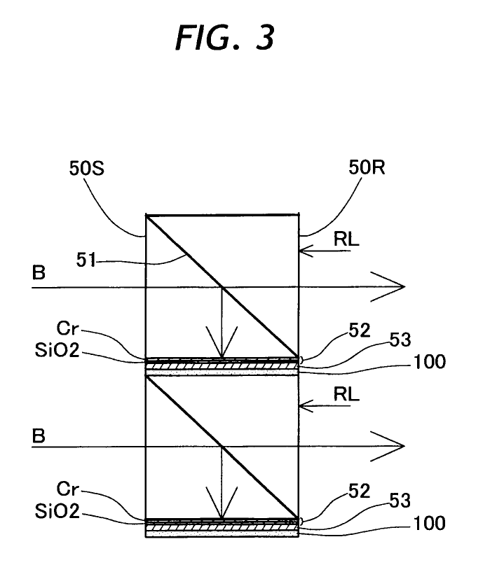

Further, according to the present invention, as shown in FIG. 3, each absorption layer 52 is covered with a reflective layer 53 which also functions as a shield layer (in the order of the absorption layer 52 and the reflective layer 53 from the side of the filtering layer 51), and an adhesive layer 100 (which bonds transparent body plates together) is formed on the reflective layer 53. The reflective layer 53 is an optical deposition film with a light reflecting function and formed of a deposition film of Al, Cr or Ti or a dielectric multi-layer deposition film of chromium oxide or the like. The reflective shield layer 53 is provided to block light might otherwise be shed on an adjacent filtering layer 51. An unnecessary component of incident light is absorbed by the absorption layer 52, which however may fail to absorb unnecessary light completely. If unnecessary light is not absorbed completely by an absorption layer 52, the remainder of unnecessary light will be transmitted through the absorption layer 52 and reflected by an adjacent filtering layer 51 in the same direction as transmitted necessary light, impairing the filtering function of the polarization filter 50.

To preclude the problem just mentioned, a reflective shield layer 53 is formed on an absorption layer 52. Even if part of unnecessary light happens to leak through the absorption layer 52, it is reflected back by the reflective layer 53 to enter the absorption layer 52 again and as a result energy of unnecessary light is completely blotted by the latter. Thus, the reflective shield layer 53 makes it surer that unnecessary light be absorbed by the absorption layers 52, preventing part of unnecessary light from leaking toward an adjacent polarization filtering layer 51. Thus, the reflective layers 53 gives a performance as a shield layer by blocking passage of unnecessary light toward an adjacent polarization filtering layer 51.

In this connection, the reflective layers 53 are not necessarily required to have a function of totally reflecting leaked unnecessary light. That is to say, basically the reflective layers 53 are provided for the purpose of preventing leakage of unnecessary light toward an adjacent polarization filtering layer 51. Therefore, each one of the reflective layers 53 mainly functions as a shield layer for block propagation of unnecessary light. It follows that the reflective layers 53 are not required to have 100% reflectivity relative to unnecessary light permeated through the absorptive layers 52. For example, the reflective layers 53 may be 60% in reflectivity. In that case, the energy of the remainder 40% of unnecessary light is blocked and absorbed by the reflective layers 53, which function as shield layers for blocking leakage of unnecessary light.

On the other hand, as described above, an adhesive layer 100 is formed on each reflective layer 53 for bonding together transparent body plates of the filter. The adhesive layers 100 are essentially formed in the fabrication of the polarization filter 50. In case a light-absorptive adhesive layer 100 is formed on each absorption layer 52 instead of a reflective layer 53 which also functions as a shield layer, there is no need for providing the reflective layers 63 any longer. Namely, by adoption of an adhesive agent 100 with light absorbing properties (a light-absorptive adhesive agent), part of unnecessary light which has permeated through the absorption layer 52 can be absorbed by the adhesive layer 100. That is to say, the adhesive layer 100 can prevent transmission of unnecessary light to an adjacent polarization filtering layer 51.

Further, it is possible to let the adhesive agent 100 play the role of the absorptive layer 52 as well. Namely, if unnecessary light can be absorbed completely by a light-absorptive adhesive agent 100, transmission of unnecessary light to an adjacent filter unit can be blocked by the light-absorptive adhesive agent alone without using the absorptive layer 52 or shield layer 53. However, in that case, it is essential for the light-absorptive agent to be able to completely absorb unnecessary light reflected off the polarization filtering layer 51.

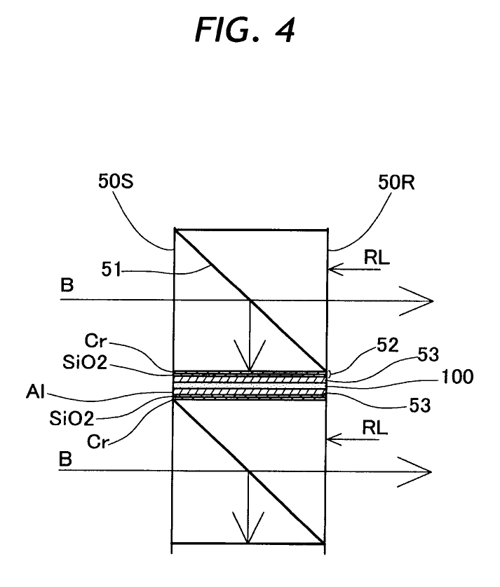

In the embodiment shown in FIG. 3, an absorptive layer 52 is provided on one side of a polarization filtering layer 51. In this case, the absorptive layer 52 is located in a position to receive a filtered-out unnecessary component which is reflected off the polarization filtering layer 51 after entering the filter 50 through the plane of incidence 50S. On the other hand, in an embodiment shown in FIG. 4, an absorptive layer 52 is provided on each side of a polarization filtering layer 51. Namely, in the case of FIG. 4, another absorptive layer 52 is added in an opposite position relative to the absorptive layer 52 shown in FIG. 3. That is to say, in addition to an absorptive layer 52 which is located on a side for absorbing an unnecessary component of light which is incident from the side of the plane of incidence 50S, another absorptive layer 52 is located on the other side for absorbing an unnecessary component of light which is incident from the side of the plane of egression 50R. The effects of removing unnecessary light can be enhanced by providing light-absorptive layers 52 on the opposite sides of a filtering layer 51 as shown in FIG. 4, for the purpose of attaining further improvements in picture quality.

More particularly, in the case of FIG. 4, of light which is incident on the plane of incidence 50S, a necessary polarization component is transmitted through the polarization filtering layer 51 while an unnecessary polarization component is reflected off. A necessary polarization component which has been transmitted through the filtering layer 51 is allowed to travel straightforward toward the polarized beam splitter 60. As shown in FIG. 1, a necessary polarization component which has entered the polarized beam splitter 60 is eventually projected on the screen 90 as a picture image. However, as indicated by the letters RL, part of light may happen to come back as return light from the side of the polarized beam splitter 60.

In a case where return light RL is s-polarized light, it may be reflected back toward the polarized beam splitter 60 to invite degradations in picture quality. Namely, in a case where an absorptive layer is provided only on one side of a polarization filtering layer 51 as shown in FIG. 3, the return light RL is reflected in an opposite direction as compared with the direction in which an unnecessary component of regularly incident light is reflected. Then, the return light RL is reflected by a reflective layer 53 without being passed through an absorptive layer 52, and cast again on the polarization filtering layer 51. Since the return light RL is s-polarized light, it is reflected off the filtering layer 51 to change its travel direction toward the polarized beam splitter 60. Thus, the return light RL acts as unnecessary light to invite degradations in picture quality. This problem can be overcome by providing an absorptive layer 52 on each side of a polarization filtering layer 51 as shown in FIG. 4. In this case, no matter from which side light enters the filter 50, from the side of the plane of incidence 50S or from the side of the plane of egression 50R, return light or an unnecessary polarization component can be surely absorbed by one of the absorptive layers 52 to guarantee high picture quality.

Further, a filter, having absorptive layers 52 on the opposite sides of each filtering layer 51 as shown in FIG. 4, has an advantageous merit in directional versatility. Namely, in case the polarization filter 50 of FIG. 2 is set in a reversed state in an optical system of a projection type display, light rays are shed on the filter 50 from the opposite direction as compared with the direction of incidence in FIG. 2. In that case, the polarization filter 50 fails to function satisfactorily in removing an unnecessary polarization component. For example, in FIG. 2, if the polarization filter 50 is set in a reversed state instead of the normally oriented position shown, light rays enter the filter from the side of the plane of egression 50R. At this time, if the reflective layers 53 are absent, part of an unnecessary polarization component, which has not been absorbed in the absorptive layers 42 is reflected off by adjacent polarization filtering layers 51 as a noise component which will cause degradations in picture quality. This problem arising from the above-explained direction-dependent performance can be precluded by providing the absorptive layers 52 on the opposite sides of each polarization filtering layer 51.

Further, in FIG. 2, a plural number of light-absorptive layers 52 are formed at intervals on the polarization filter 50, including the one which is formed on one of parallel end faces of the polarization filter 50. In this instance, leakage of an unnecessary polarization component can take place at the other end face without an absorptive layer 51, causing degradations in picture quality as noises. Therefore, it is desirable to provide a light-absorptive layer 52 on each end face of the polarization filter 50. In this regard, a light-absorptive layer 52 is necessarily formed on each one of the end faces of the polarization filter 50 in a case where absorptive layers 52 are provided on the opposite sides of each polarization filtering layer 51 as described hereinbefore.

Thus, in order to enhance the effects of removing unnecessary polarizations and from the standpoint of above-mentioned directional versatility, preferably the light-absorptive layers 52 should be provided on the opposite sides of each polarization filtering layer 51. However, the basic filter construction, having an absorptive layer 52 only on one side of each polarization filter layer 51 as shown in FIG. 3, can produce filtering effects to a satisfactory degree in removing an unnecessary polarization.

In a case where light-absorptive layers 52 are to be provided on the opposite sides of each polarization filtering layer 51 in combination with reflective layers 53, an absorptive layer 52, a reflective layer 53, an adhesive layer 100, a reflective layer 53 and an absorptive layer 52 are formed in that order between two adjacent filtering layers 51 as shown in FIG. 4. In this instance, the reflective layers 53 suffice to have a function of reflecting unnecessary light. Therefore, there is no need for providing the reflective layers 53 at two separate positions, that is to say, it suffices to provide one reflective layer 53 (i.e., it suffices to employ one reflective layer 53 in the order of an absorptive layer 52, a reflective layer 53, an adhesive layer 100 and an absorptive layer 52, omitting the other reflective layer 53).

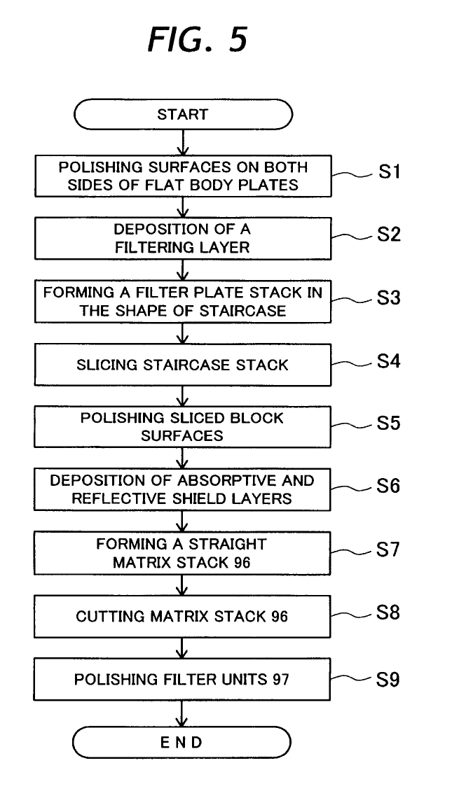

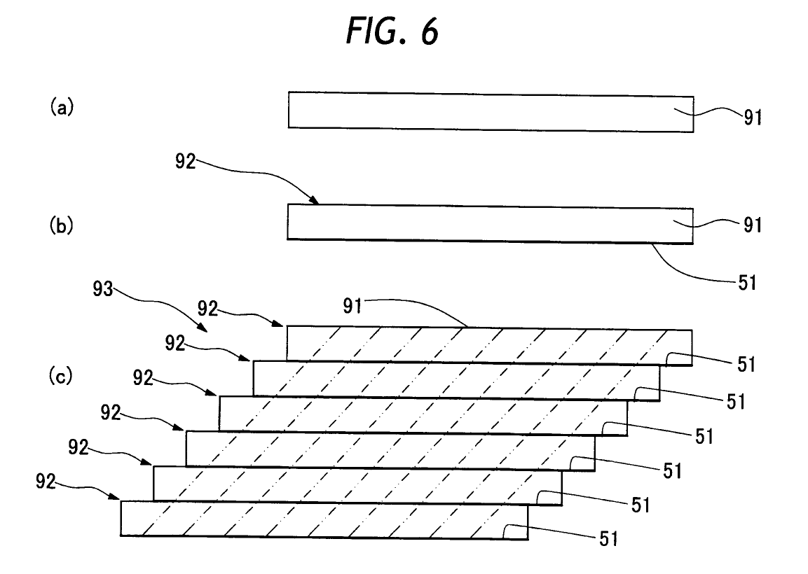

Now, reference is had to the flow chart of FIG. 5, showing steps of a process for manufacturing the polarization filter 50. The manufacturing process starts with a step of polishing surfaces on both sides of transparent flat body plate units 91 or the like as shown in FIG. 6(a) (STEP 1: POLISHING SURFACES ON BOTH SIDES OF FLAT BODY PLATES). In order to perform predetermined optical functions, surfaces on opposite sides of each flat body plate unit 91 should be polished to a high degree of planeness before depositing a polarization filtering layer 51 on one of them. In this instance, as explained step by step hereinafter, the flat body plate units 91 are processed through a number of stages, including stages for deposition of various optical layers and stacking and cutting stages, to obtain an ultimate product of the polarization filter 50. The flat body plate units 91 are formed of the same material as the transparent member 59 of the polarization filter 50. Of course, Step 1 (S1) can be omitted in case surface of the flat body plate units 91 already have a high degree of planeness as required.

As shown in FIG. 6(b), a polarization filtering layer 51, with a function of filtering out a specific polarization, is deposited on one of polished surfaces of each flat body plate unit 91 to obtain a filter plate 92 (STEP 2: DEPOSITION OF A FILTERING LAYER). Then, as shown in FIG. 6(c), a filter plate stack 93 is formed by stacking the filter plates 92 in the fashion of a staircase (STEP 3: FORMING A FILTER PLATE STACK IN THE SHAPE OF STAIRCASE). In order to make a filter plate stack 93, a plural number of filter plates 92 are prepared in Steps 1 and 2 (S1 and S2). The filter plate stack 93 is formed in the shape of a staircase with an angle of inclination which is determined by an angle of inclination of polarization filtering layers 51 to be formed on the polarization filter 50. Generally, the filtering layers 51 are formed at the angle of 45 degrees relative to incident light. In the particular example shown, the staircase-like stack 93 of the filter plate units 92 is inclined at an angle of 45 degrees relative to its base line. To this end, an overlying filter plate unit 92 is staggered from an underlying filter plate unit 92 by a distance corresponding to the thickness of the filter plate 92. In this manner, the filter plates 92 are bonded successively to form a stack 93 which is staggered in the shape of a staircase with an angle of inclination of 45 degrees.

In the next place, the filter plate stack 93 is cut along oblique cut lines which are drawn at uniform intervals and at the same angle as the angle of inclination of the staircase-like stack 93 obtain sliced staircase blocks 94 (STEP 4: SLICING STAIRCASE STACK). Surfaces on the opposite sides of each sliced staircase block 94, cut from the staircase-like stack 93, should have a high degree of planeness because an absorptive layer 52 and a reflective layer 53 are deposited thereon in a later stage (i.e., in Step 6). Since it is difficult to impart a high degree of planeness in the course of a cutting operation, surfaces on the opposite sides of each sliced staircase block 94 are polished in a next step (STEP 5: POLISHING SLICED BLOCK SURFACES) following the cutting operation in Step 4. Of course, Step 5 may be omitted in a case where surfaces of the sliced staircase blocks 94 already have a satisfactorily high degree of planeness.

Then, a light-absorptive layer 52 and a reflective shield layer 53 are deposited on polished surfaces of each sliced staircase block 94 (STEP 6: DEPOSITION OF ABSORPTIVE AND REFLECTIVE SHIELD LAYERS). There are differences in contents of Step 6 between a case where an absorptive layer 52 is to be formed on one side of each polarization filtering layer 51 alone and a case where absorptive layers 52 are to be formed on the opposite sides of each polarization filtering layer 51. Firstly, in a case where an absorptive layer 52 and a reflective layer 53 are to be provided on one side of each filtering layer 51, an absorptive layer 52 is deposited on a surface 94S on one side of a sliced staircase block 94 and then a reflective layer 53 is deposited on the absorptive layer 52 to obtain a coated staircase block 95. On the other hand, in a case where an absorptive layer 52 and a reflective layer 53 are to be provided on each side of a filtering layer 51, an absorptive layer 52 is deposited on each one of surfaces 94S and 94R on the opposite sides of a staircase block 94, followed by deposition of a reflective layer 53. Step 5 and Step 6 are carried out for each one of the sliced staircase blocks 94 which are cut from a staircase-like stack 93 of filter plate units 92 to prepare a plural number of coated staircase blocks 95.

In this regard, in a case where an absorptive layer 52 and a reflective layer 53 are to be provided on one side of a polarization filtering layer 51 alone and an absorptive layer 52 and a reflective layer 53 are to be deposited simultaneously on a plural number of sliced staircase blocks 94, the respective layers 52 and 53 should be deposited on the same surfaces 94S on one side of the staircase blocks 94 because, if there is a staircase slice 94 having the respective layers 52 and 53 deposited on the other surface 94R, it will impair the function of absorbing unnecessary polarizations.

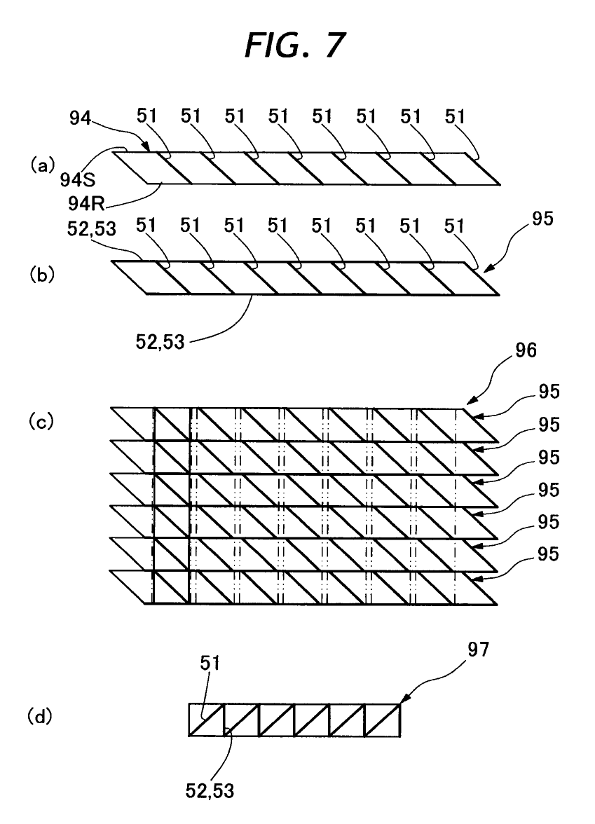

In the next place, as shown in FIG. 7(c), the coated staircase blocks 95 are stacked straight up one on another to form a straight matrix stack 96 (Step 7: FORMING A STRAIGHT MATRIX STACK 96). Although the filter plate units are stacked in staggered positions in the staircase-like stack 93, the coated staircase slices 95 are stacked straight up in the straight matrix stack 96. Similarly to the staircase-like stack 93, a plural number of stacked plates (coated staircase blocks 95) are bonded together by the use of an adhesive at the time of forming the straight matrix stack 96. A plural number of unfinished filter units 97, each in the form of a rectangular parallelepiped block as shown in FIG. 7(d), are obtained by cutting the matrix stack 96 along uniformly spaced vertical cut lines (Step 8: CUTTING MATRIX STACK 96). The unfinished filter units 97 are substantially same as polarization filter 50 of the end product. However, as indicated in the drawing, cut lines for the unfinished filter units 97 are so determined as to count in an allowance margin in anticipation of stock removal in a polishing operation in a finishing stage.

The plane of incidence 50S as well as the plane of egression 50R of the polarization filter 50 should be strictly in perpendicularly intersecting relation with incident light rays. On the other hand, the cut surfaces of an unfinished filter units 97, which will make the plane of incidence 50S and the plane of egression 50R of the polarization filter 50, are not necessarily guaranteed to be satisfactory in planeness. Therefore, cut surfaces of the filter units 97 are polished to a high degree of planeness (Step 9: POLISHING FILTER UNITS 97). By this polishing operation, the polarization filter 50 is imparted with high optical accuracy.

Deposition of the reflective layer 53 can be omitted in a case where the adhesive layer 100 is of a light-absorptive adhesive agent which can play the role of the reflective layer 53 as well. In addition, the absorptive layer 52 can also be omitted in a case where the light-absorptive adhesive agent can also play the role of the absorptive layer 53.

As mentioned above, for a filtering function, the polarization filter 50 has a series of filtering layers 51 formed at predetermined angles in a transparent body material in the shape of a flat plate. This filtering layer arrangement permits to reduce the thickness of the filter 50 to a significant degree, and can contribute to compactification of an optical appliance as a whole. Namely, the filtering layer 51, which would normally be formed on one plane, is divided into a plural number of filtering layer sections which are arranged in a row successively and continuously, to give a satisfactory performance as a polarization filter while permitting reductions in thickness. In this connection, all of light rays incident on the plane of incidence 50A of the filter 50 have to be shed on the filtering layer sections 51, and no gap or interstice should be opened up between adjacent filtering layer sections in a direction of propagation of incident light because leakage of light through such a gap space would impair the filtering function of the polarization filter.

However, according to the manufacturing process described above, the coated staircase slices 95 are stacked gapless in the vertical direction at the time of forming a matrix stack 96 in Step 7. As shown in FIGS. 7(c) and 7(d), the matrix stack 96 is cut along vertical cut lines, that is, in a direction perpendicular to the direction of incident light rays. Since the coated staircase slices 95 are stacked and bonded gapless at the time of forming the matrix stack 96, there is no possibility of a gap being opened up in the direction of light incidence. Thus, following the above-described steps of the filter fabrication process, one can obtain a polarization filter which is free of gaps and yet reduced in thickness.

In this connection, in a case where an optical adhesive agent is used for bonding together a plural number of filter plate units 92 in building up a staircase-like stack 93 in Step 3 described above, an adhesive agent other than an optical adhesive agent is used for bonding together the coated staircase blocks 95 in building up a matrix stack 96. This is because an optical adhesive agent is an adhesive which is used for bonding together transparent optical elements of glass or the like. More specifically, in place of an ordinary adhesive agent, an optical adhesive agent is especially used at the time of bonding light transmitting surfaces of transparent optical elements to prevent attenuation of transmitted light. For this purpose, an optical adhesive agent should have a matching refractivity with optical glass elements or the like, along with a satisfactory light transmittance.

In the present invention, the filter plate units 92 are coated with a polarization filtering layer 51 on the respective joining surfaces. The filtering layer 51 has functions of transmitting signal light while reflecting unnecessary light. After transmission through the filtering layer 51, signal light is passed through joined surfaces. Thus, the filter plate units 92 are bonded with each other by the use of an optical adhesive agent to suppress attenuation of transmitted light to a minimum.

On the other hand, the coated staircase blocks 95 have an absorptive layer 52 and a reflective layer 53 deposited on the respective joining surfaces. As mentioned hereinbefore, the absorptive layer 52 has a function of absorbing unnecessary light while the reflective layer 53 has a function of totally reflecting unnecessary light. That is to say, no light is transmitted through joined surfaces of the coated staircase blocks 95, or preferably no light should be allowed to be transmitted through the joined surfaces of the staircase blocks 95. Therefore, an adhesive agent other than an optical adhesive agent is used more positively for bonding together the coated staircase blocks 95. In this regard, the energy of unnecessary light which is absorbed by the absorptive layer 52 is converted into thermal energy, and as a result accumulation of heat takes place in the absorptive layer 52. The accumulated heat is transmitted to the adhesive agent through the metallic reflective layer 53, putting the adhesive agent in high temperature conditions. Therefore, it is desirable to employ an adhesive which has satisfactory properties in durability and resistance to heat. An adhesive agent with such properties is free from the problem of defoliation which might occur in heated conditions.

As explained above, the polarization filter of the present invention has a plural number of filtering layers in series in a gapless state in a direction perpendicular to the travel direction of incident light, in such a way as to permit reductions in thickness, achieving compactification of the filter construction as a whole. Especially, in a filtering and absorptive layer arrangement employing a plural number of absorptive layers for each filtering layer, unnecessary components separated from signal light can be completely blotted up in a reliable manner to preclude adverse effects of unnecessary light components on the quality of projected images.

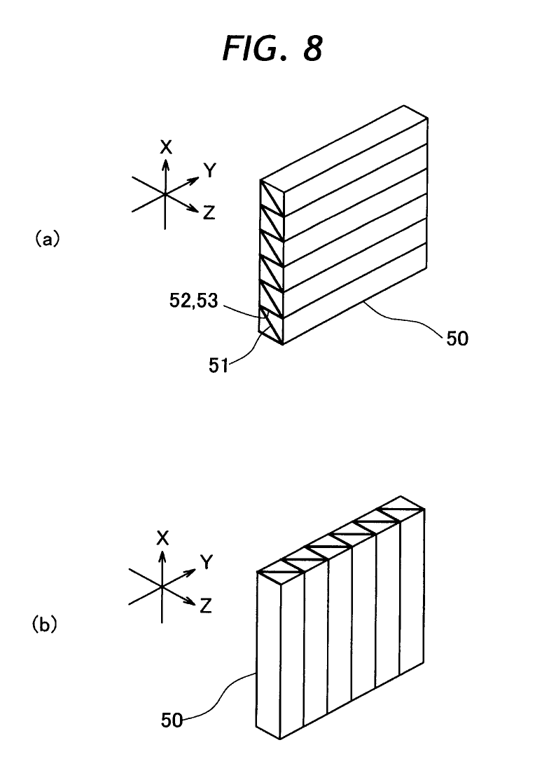

In the case of the particular application exemplified in FIG. 1, the polarization filter 50 is positioned to transmit a p-polarization component as signal light and to reflect off an s-polarization component as unnecessary light. However, the polarization filter of the present invention can also be applied to transmit an s-polarization component as signal light while reflecting a p-polarization component as unnecessary light. In this connection, shown in FIGS. 8(a) and 8(b) are two cases of filtration in relation with three orthogonal axes, X-, Y- and Z-axes, of which Z-axis coincides with the travel direction of incident light. Shown in FIG. 8(a) is a case of a polarization vibrating in a plane in the direction of X-axis, and shown in FIG. 8(b) is a case of a polarization vibrating in a plane in the direction of Y-axis. Since the direction of polarization is determined depending upon the plane of incidence of the filter 51. In the case of FIG. 8(a), a polarization vibrating in a plane in the direction of X-axis is p-polarized light (indicated by B(X)), and, in the case of FIG. 8(b), a polarization vibrating in a plane in the direction of Y-axis is p-polarized light (indicated by B(Y)).

In a case where the polarization filter 50 is positioned in the manner as shown in FIG. 8(a), an incident light component vibrating in a plane parallel with B(X), p-polarization is transmitted through the filter 50, while a polarization perpendicular to B(X) is reflected off. On the other hand, in the case of FIG. 8(b) with a plane of incidence turned through 90 degrees, an incident light component vibrating in a plane parallel with B(Y) is transmitted through the filter 50, while a polarization perpendicular to B(Y) is reflected off. Thus, the filtering function of the polarization filter 50 can be changed from p-polarization to s-polarization or vice versa by shifting the position of the filter 50 (by turning the plane of incidence) in relation with directions of polarizations of incident light as shown in FIGS. 8(a) and 8(b).

What is claimed is:

1. An optical filter capable of removing an unnecessary component of incident light, comprising:
a plurality of filtering layers each configured to transmit a necessary component of incident light while reflecting an unnecessary component, said filtering layers provided in series and at uniform intervals within a transparent flat plate-like body with a predetermined inclination angle relative to a travel direction of incident light; and
a plurality of light-absorptive deposition layer films having light absorbing properties and configured to absorb said unnecessary component of incident light reflected at said filtering layers, said light-absorptive deposition film layers each provided within said transparent plate-like body in series and at uniform intervals corresponding to each of said plurality of filtering layers;
a plurality of reflective layers formed under each of said plurality of light-absorptive deposition layer films and configured to reflect a remainder of said unnecessary light permeating through each of said light-absorptive deposition film layers;
said light-absorptive deposition layer films and said reflective layers being laminated with each other at the positions between every adjacent filtering layers.

2. An optical filter as set forth in claim 1, wherein said optical filter is a polarization filter configured to transmit either p- or s-polarization, and said plurality of filtering layers are polarization separating deposition film layers.

3. A projection display incorporating an optical filter as set forth in claim 2.
